(19) United States
(12) Patent Application Publication
(10) Pub. No.: US 2025/0142042 A1
(43) Pub. Date: May 1, 2025

(54) Adjusting Interaxial Distance for Stereoscopic Cameras via Image Sensor Offset

(71) Applicant: Apple Inc., Cupertino, CA (US)

(72) Inventors: Ryan M. Sheridan, Huntington Beach, CA (US); Matthew J. Yaeger, Tustin, CA (US)

(21) Appl. No.: 18/929,234

(22) Filed: Oct. 28, 2024

Related U.S. Application Data
(60) Provisional application No. 63/593,702, filed on Oct. 27, 2023.

(51) Int. Cl. H04N 13/296; H04N 13/161; H04N 13/239; H04N 13/271

(52) U.S. Cl. CPC H04N 13/296; H04N 13/161; H04N 13/239; H04N 13/271

(57) ABSTRACT

A stereoscopic camera includes left and right camera lenses associated with respective left and right camera sensors. The alignment of the left and right camera lenses is shifted relative to their respective image sensors. Additionally, shifting the alignment of the camera lenses relative to one another alters the interaxial distance between the lenses. The interaxial distance is adjustable, or fixed, between 58 mm and 74 mm. Realignment of the lenses causes at least one, or both, of the lenses' optical axis to be off-center of the lenses' respective sensor. A region of interest is determined for each image sensor where each lens overlaps its respective image sensor. Based on the determined region of interest, unused portions of an image sensor readout are discarded.

### BACKGROUND

Stereoscopic cameras are widely used to simulate human vision. A stereoscopic camera may be used, for example, to capture image data and provide a viewer with the illusion of three-dimensional depth. A typical stereoscopic camera includes a pair of camera lenses (e.g., left/right lenses) and a pair of image sensors (e.g., left/right sensors). Stereoscopic camera rigs outfitted with high-powered lenses have about a 100 mm interaxial distance. Stereoscopic image content viewed at a 100 mm interaxial distance is disorienting to a viewer.

### SUMMARY

In one embodiment, a stereoscopic camera is provided. The stereoscopic camera may include a left camera lens and a right camera lens separated by a first distance. Additionally, the stereoscopic camera may include a left camera sensor and a right camera sensor separated by a second distance. The left camera sensor is associated with the left camera lens and the right camera sensor is associated with the right camera lens. The stereoscopic camera may include a controller that is configured to (i) receive image data from the left camera sensor and the right camera sensor, and (ii) encode the received image data. In some embodiments, the left camera lens' optical axis may be off-center of the left camera sensor. Additionally, or alternatively, the right camera lens' optical axis may be off-center of the right camera sensor. The stereoscopic camera may include additional, less, or alternate functionality, including that discussed elsewhere herein.

In another embodiment, a system including a stereoscopic camera and one or more processors coupled to a memory may be provided. The stereoscopic camera may include a left camera lens associated with a left sensor and a right camera lens associated with a right sensor. The left and right camera lens may be an interaxial distance away from each other, causing at least one of the left and right camera lenses to be offset from their respective image sensor. The at least one processor may be configured to: (i) adjust the interaxial distance between the left and right camera lens, (ii) obtain sensor readout data from the left and right sensors, (iii) remove unused portions of the sensor readout data, and (iv) cause to be displayed the sensor readout data on a display device. In some embodiments, the adjustment to the interaxial distance causes the right camera lens' optical axis to be off-center of the right sensor. Additionally, or alternatively, the left camera lens' optical axis may be off-center of the left camera sensor. The system may include additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. Each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown.

FIG. 1 shows, in block diagram form, a simplified image capture device according to one or more embodiments.

FIG. 2A shows an example stereoscopic camera assembly with variable interaxial distance using an extra-wide sensor, in accordance with one or more embodiments.

FIG. 2B shows an example stereoscopic camera assembly with an off-center optical axis and a fixed interaxial distance, in accordance with one or more embodiments.

FIG. 2C shows an example stereoscopic camera assembly in accordance with one or more embodiments.

FIGS. 3A-3C show an example lens modification according to one or more embodiments.

FIG. 4 shows an example stereoscopic image frame according to one or more embodiments.

FIG. 5 shows, in flowchart form, an example method of stereoscopic lens sensor offset according to one or more embodiments.

FIG. 6 shows, in block diagram form, a simplified multifunctional device according to one or more embodiments.

The Figures depict preferred embodiments for purposes of illustration only. One skilled in the art will readily recognize from the following discussion that alternative embodiments of the systems and methods illustrated herein may be employed without departing from the principles of the embodiments described herein.

### DETAILED DESCRIPTION

This disclosure relates to the field of digital image capture and processing, and more particularly to the interaxial distance adjustment of stereoscopic camera optical stacks. Additionally, this disclosure pertains to a stereoscopic camera assembly providing a pair of high-powered lenses with a fixed interaxial distance. In general, techniques are disclosed for using a custom mount to secure the lenses at a fixed interaxial distance, such as 64 mm, without adjusting image sensors that correspond to the lenses. For example, with an interaxial distance of 64 mm, the at least one of the lenses may have an off-center optical axis. Each image sensor of the camera assembly may read out a region of interest (ROI) captured by its respective lens, discarding unused portions of the sensor. Alternatively, each image sensor may read out all data detected, including used and used portions of the image sensor.

In the following description, for purposes of explanation, specific details are set forth to provide a thorough understanding of the disclosed concepts. As part of this description, some of this disclosure's drawings represent structures and devices in block diagram form to avoid obscuring the novel aspects of the disclosed embodiments. In this context, it should be understood that references to numbered drawing elements without associated identifiers (e.g., 105) refer to all instances of the drawing element with identifiers (e.g., 105A and 105B). Further, as part of this description, some of this disclosure's drawings may be provided in the form of a flow diagram. The boxes in any particular flow diagram may be presented in a particular order. However, the flow of any flow diagram is used only to exemplify one embodiment. In other embodiments, any of the various components depicted in the flow diagram may be deleted, or the components may be performed in a different order, or even concurrently. In addition, other embodiments may include additional steps not depicted as part of the flow diagram. The language used in this disclosure has been principally selected for readability and instructional purposes and may not have been selected to delineate or circumscribe the disclosed subject matter. Reference in this disclosure to “one embodiment” or to “an embodiment” means that a particular feature, structure, or characteristic described in connection with the embodiment is included in at least one embodiment, and multiple references to “one embodiment” or to “an embodiment” should not be understood as necessarily all referring to the same embodiment or to different embodiments.

It should be appreciated that in the development of any actual implementation (as in any development project), numerous decisions must be made to achieve the developers' specific goals (e.g., compliance with system and business-related constraints), and that these goals will vary from one implementation to another. It will also be appreciated that such development efforts might be complex and time consuming but would nevertheless be a routine undertaking for those of ordinary skill in the art of image capture having the benefit of this disclosure.

For purposes of this disclosure, the term “camera” refers to a lens assembly, along with the sensor element and other circuitry utilized to capture an image. For purposes of this disclosure, two or more cameras may share a single sensor element and other circuitry but include two different lens assemblies. However, in one or more embodiments, two or more cameras may include separate lens assemblies, as well as separate sensor elements and circuitry.

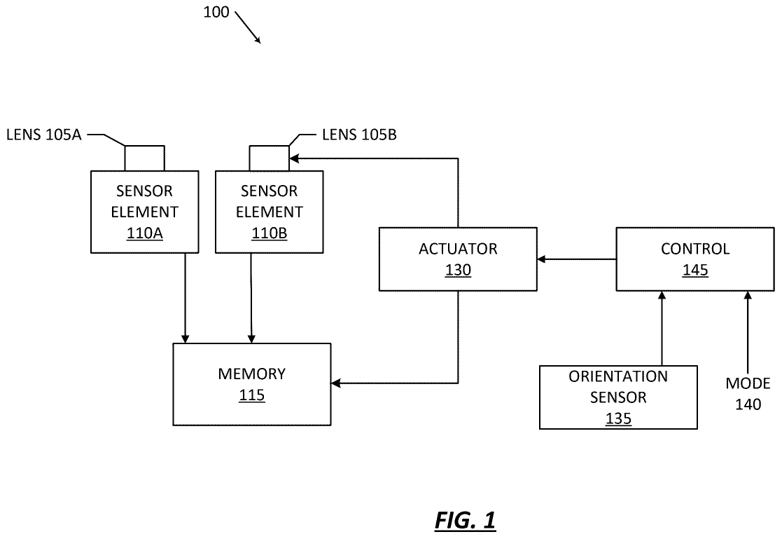

Referring to FIG. 1, a simplified block diagram of camera system 100 is depicted, in accordance with one or more embodiments of the disclosure. Camera system 100 may be part of a camera, such as a digital camera. Camera system 100 may also be part of a multifunctional device, such as a mobile phone, tablet computer, personal digital assistant, portable music/video player, or any other electronic device that includes a camera system.

Camera system 100 may include one or more lens assemblies 105. More specifically, as described above, lens assemblies 105A and 105B may each include a lens assembly, which may include a number of optical lenses, each with various lens characteristics. For example, each lens assembly 105 may include its own physical imperfections that affect the quality of an image captured by the particular lens assembly. When multiple lenses are combined, for example in the case of a compound lens, the various physical characteristics of the lenses may impact the characteristics of images captured through the lens assembly, such as focal points. In addition, each of lens assemblies 105A and 105B may have similar characteristics, or may have different characteristics, such as a different depth of field (DOF).

As depicted in FIG. 1, camera system 100 may also include sensor elements 110A and 110B. Sensor elements 110 may be sensors that detect and convey the information that constitutes an image. Light may flow through the corresponding lens assembly 105 prior to being detected by sensor element 110 and be stored, for example, in memory 115. In one or more embodiments, the camera system 100 may include multiple lens assemblies 105A and 105B, and each of the lens assemblies may be associated with a different sensor element, or one or more of the lens assemblies may share a sensor element 110.

Camera system 100 may also include an actuator 130, and mode select input 140. In one or more embodiments, actuator 130 may manage control of one or more of the lens assemblies 105, for example by moving one or both of the lens assemblies of the stereoscopic camera. For example, the actuator 130 may shift the alignment of lens 105A and/or 105B in relation to their respective image sensor elements 110A and 110B. In some embodiments, the geometric centers of image sensor elements 110A and 110B may be a fixed distance apart to allow for a variable interaxial distance between lenses 105A and 105B. For example, image sensor elements 110A and 110B may be spaced 69 mm apart from each other. At this distance, the adjustable interaxial range between lenses 105A and 105B may be 48 mm and 90 mm. In another example, image sensor elements 110A and 110B may be spaced about 400 mm apart from each other. At this distance, the adjustable interaxial range between lenses 105A and 105B may be around 380 mm and 420 mm. Additionally, or alternatively, lenses 105A and 105B may be mounted at a fixed interaxial distance (e.g., 90 mm) and offset from image sensor elements 110A and 110B (e.g., 69 mm). Orientation sensor 135 and mode select input 140 may supply input to a controller, such as control unit 145. In one embodiment, camera system may use a charged coupled device (or a complementary metal-oxide semiconductor as sensor element 110), an electro-mechanical unit (e.g., a voice coil motor) as actuator 130. Although FIG. 1 depicts two sensor/lens combinations associated with a single memory 115 and actuator 130, in one or more embodiments, each sensor/lens pair may be associated with a separate image capture circuitry.

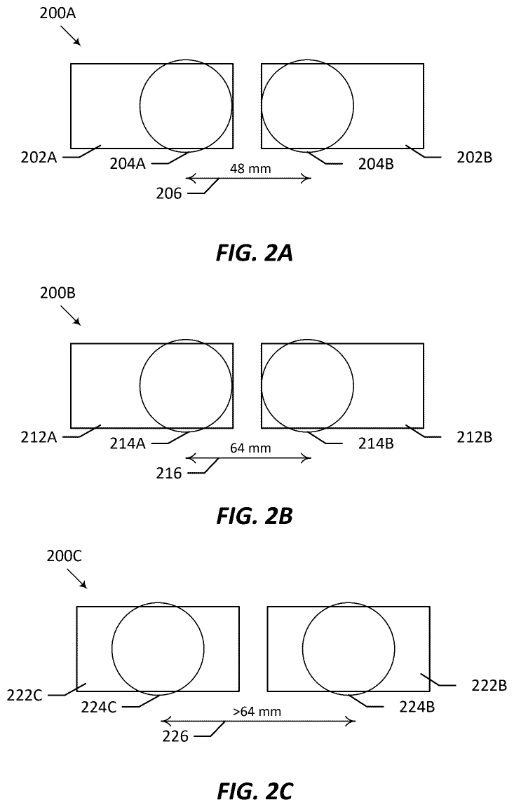

Referring now to FIGS. 2A-2C, example camera lens and image sensor pairs 200A, 200B and 200C are shown according to one or more embodiments. Camera lens and image sensor pairs 200A and 200B may be part of a stereoscopic camera assembly, such as camera system 100 of FIG. 1.

As shown in FIG. 2A, camera lens and image sensor pair 200A includes a left camera lens 204A, a left image sensor 202A, a right camera lens 204B, and a right image sensor 202B. As depicted, camera lenses 204A and 204B are separated by an interaxial distance 206. In this example, the interaxial distance is 48 mm. In some embodiments, the interaxial distance may be a variable distance based on an adjustment of the position of the lenses with respect to each other. Alternatively, the interaxial distance may be a fixed distance. Left image sensor 202A and right image sensor 202B may be extra wide sensors.

As shown in FIG. 2B, camera lens and image sensor pair 200B includes a left camera lens 214A, a left image sensor 212A, a right camera lens 214B, and a right image sensor 212B. As depicted, camera lenses 214A and 214B are separated by an interaxial distance 216. In this example, the interaxial distance is 64 mm. In some embodiments, the interaxial distance may be a variable distance based on an adjustment of the position of the lenses with respect to each other. Alternatively, the interaxial distance may be a fixed distance. Left image sensor 212A and right image sensor 212B may be extra wide sensors.

As shown in FIG. 2C, camera lens and image sensor pair 200C includes a left camera lens 224C, a left image sensor 222C, a right camera lens 224B, and a right image sensor 222B. As depicted, camera lenses 224C and 224B are separated by an interaxial distance 226. In this example, the interaxial distance may be greater than 64 mm. In some embodiments, the interaxial distance may be a variable distance based on an adjustment of the position of the lenses with respect to each other. Alternatively, the interaxial distance may be a fixed distance. Left image sensor 222C and right image sensor 222B may be extra wide sensors.

In some embodiments, either the left camera lens or the right camera lens may be adjusted, or shifted, while their respective image sensors remain fixed. For example, only lens 204A may be moved, or shifted, in relation to its corresponding image sensor, such as image sensor 202A, thereby changing the interaxial distance between lens 204A and lens 204B. In another embodiment, only lens 204B may be moved, or shifted, in relation to its corresponding image sensor, such as image sensor 202B, thereby changing the interaxial distance between lens 204A and lens 204B. Alternatively, both the left camera lens and the right camera lens may be adjusted, such as by moving them towards one another or away from one another.

As the interaxial distance changes, as described above, a region of interest of the image sensors may change. The region of interest may correspond to a portion of the sensor from which sensor data is usable for image processing. For example, a region of interest may be determined based on a position of where a camera lens, such as lens 204A or lens 204B, is positioned over a corresponding image sensor, such as image sensor 202A or image sensor 202B. In response to a change in a position of a lens with respect to a corresponding sensor, the region of interest will need to be updated. This may occur, for example, when a lens stack is moved to a new position to modify an interaxial distance between the lens stack and a second lens stack in a stereoscopic camera.

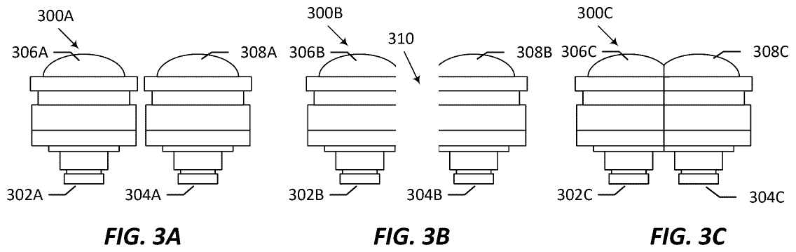

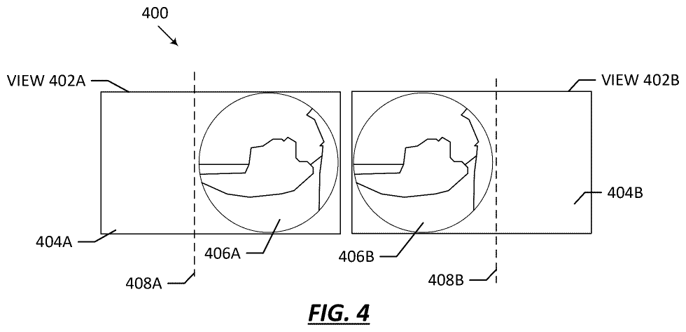

Referring now to FIGS. 3A-3C, an example modification to camera lens pair 302 and 304 is depicted. In some embodiments, the interaxial distance between two stereoscopic lenses, such as 204A or lens 204B, may be a fixed distance. The fixed interaxial distance may be, for example, between 48 mm and 90 mm. The lens pair in an unmodified state is shown in 300A. The lens pair in modification state is shown in diagram 300B. And the lens pair in modified state is shown in 300C. The lens pair in 300A may include a stereoscopic camera assembly, such as a left lens optical stack 302A and a right lens optical stack 304A. The left and right optical stacks 302A and 304A may include lenses 306A and 308A, respectively. Lenses 306A and 308A may be high-powered lenses. The interaxial distance between lenses 306A and 308A may be 76 mm. FIG. 3B depicts in diagram 300B modification of the camera lens optical stacks 302B and 304B and respective lenses 306B and 308B. In modification, a portion of the lens pair assembly has been removed, as indicated by blank space 310. Portions of the lens assembly may be removed, for example, using a cutting machine, such as a waterjet cutting machine that uses a thin high-pressure water jet. After removal of the portion of the lens pair assembly, the left lens optical stack 302C is attached to right lens optical stack 304C, along with respective camera lenses 306C and 308C. The modified stereoscopic pair may provide a stereoscopic view, such as the example view 400 provided in FIG. 4.

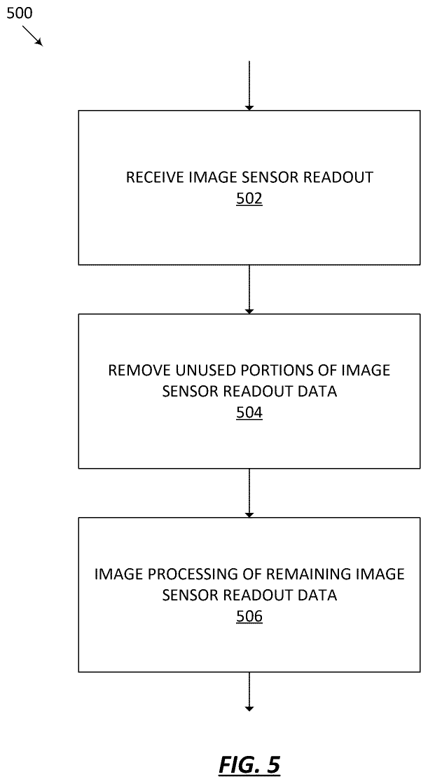

Referring now to FIG. 4, image view 400 provides example views 402A and 402B captured by a stereoscopic image sensor pair, such as sensor elements 404A and 404B. Left view 402A includes image data 406A captured by an image sensor and its respective camera lens, such as lens 105A of FIG. 1. Image data 406A illustrates where a camera lens overlaps with the image sensor. Portions outside of the circle of image data 406A are unused portions (e.g., null data) of the image sensor. Sensor data from the unused portion may be discarded. In some embodiments, a portion of the sensor capturing image data, such as 406A, may include a region of interest. In some embodiments, the region of interest may include some of the unused portions. For example, a region of interest may be delineated based on a boundary on the sensor at which image data is captured, such as broken line 408A. Data to the left of broken line 408A may be outside the region of interest, and thus may be discarded during image processing. As described herein, the region of interest may correspond to a portion of the sensor from which sensor data is usable for image processing. For example, a region of interest may be determined based on a position of where a camera lens is positioned over a corresponding image sensor. In FIG. 4, the region of interest may be within the circle 406A. Alternatively, the region of interest may be all data to the right of boundary 408A or the entire sensor. Similar to view 402A, right view 402B includes image data 406B captured by an image sensor and its respective camera lens, such as lens 105B of FIG. 1. Image data 406B illustrates where a camera lens overlaps with the image sensor. Portions outside of the circle of image data 406B are unused portions (e.g., null data) of the image sensor. Data to the right of broken line 408B may be outside the region of interest, and thus may be discarded during image processing. Another region of interest may be determined based on a position of where a camera lens is positioned over a corresponding image sensor. In FIG. 4, the region of interest may be within the circle 406B. Alternatively, the region of interest may be all data to the left of boundary 408B or the entire sensor. Data removal of unused portions of an image sensor is described in conjunction with FIG. 5.

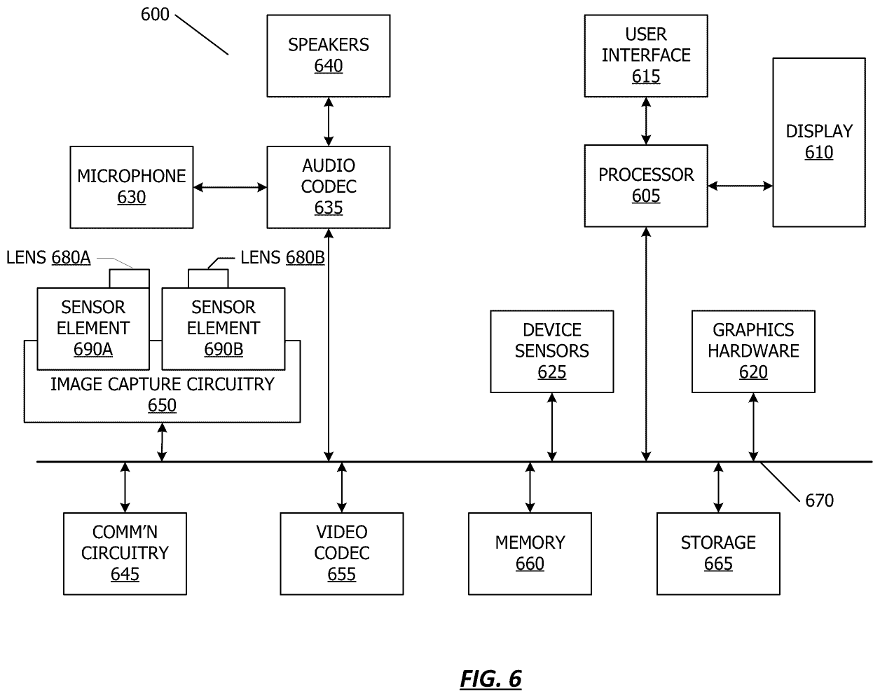

Referring now to FIG. 5, the figure depicts an exemplary method 500 for discarding image data associated with unused portions of an image sensor. Method 500 may be performed by a computing device, such as a computing device described by FIG. 6. Further, steps of method 500 may be performed in conjunction with one or more user devices or stereoscopic camera assembly rigs, such as the stereoscopic camera assembly illustrated in FIG. 1.

Method 500 may include receiving 502 image sensor readout data from an image sensor. Sensor readout data may include, for example, image data captured by the entire image sensor, including where a camera lens overlaps with the image sensor and where the camera lens does not overlap with the image sensor. Where the camera lens overlaps with the image sensor is considered a region of interest. If the camera lens moves or is shifted, where the lens overlaps with the image sensor may change. In response to a shift of the camera lens, the region of interest is updated to correspond to where the lens now overlaps with the image sensor. Alternatively, sensor readout data may include, for example, data from a partial image sensor readout. In this example, the sensor would only read out data corresponding to the region of interest, or where the camera lens overlaps with the image sensor (e.g., FIG. 4, region of interest circle 406A overlaps sensor 404A). In some embodiments, only the pixels of the image sensor that correspond to the region of interest would be included in the partial image sensor readout. For example, the partial image sensor readout would only include pixels of the image sensor pixel array (e.g., identified by column and row) that correspond to the region of interest.

Method 500 may include removing 504 unused portions of image sensor readout data. Image sensor readout data may include data that corresponds to the region of interest as well as data that corresponds to unused portions of the image sensor. Unused portions may correspond to, for example, portions of the image sensor that are outside of the region of interest. Data of this ilk has little or no value and may be ignored. In some embodiments, the image data that corresponds to the unused portions may be removed and discarded. By removing unused portions, image processing 506 may be performed on the remaining image sensor readout data. The remaining image sensor readout data may correspond to, for example, the region of interest.

Referring now to FIG. 6, a simplified functional block diagram of illustrative multifunction device 600 is shown according to one embodiment. Multifunction electronic device 600 may include processor 605, display 610, user interface 615, graphics hardware 620, device sensors 625 (e.g., proximity sensor/ambient light sensor, accelerometer and/or gyroscope), microphone 630, audio codec(s) 635, speaker(s) 640, communications circuitry 645, digital image capture circuitry 650 (e.g., including camera system 100) video codec(s) 655 (e.g., in support of digital image capture unit 650), memory 660, storage device 665, and communications bus 670. Multifunction electronic device 600 may be, for example, a digital camera or a personal electronic device such as a personal digital assistant (PDA), personal music player, mobile telephone, or a tablet computer.

Processor 605 may execute instructions necessary to carry out or control the operation of many functions performed by device 600 (e.g., such as the generation and/or processing of images and single and multi-camera calibration as disclosed herein). Processor 605 may, for instance, drive display 610 and receive user input from user interface 615. User interface 615 may allow a user to interact with device 600. For example, user interface 615 can take a variety of forms, such as a button, keypad, dial, a click wheel, keyboard, display screen and/or a touch screen. Processor 605 may also, for example, be a system-on-chip such as those found in mobile devices and include a dedicated graphics processing unit (GPU). Processor 605 may be based on reduced instruction-set computer (RISC) or complex instruction-set computer (CISC) architectures or any other suitable architecture and may include one or more processing cores. Graphics hardware 620 may be special purpose computational hardware for processing graphics and/or assisting processor 605 to process graphics information. In one embodiment, graphics hardware 620 may include a programmable GPU.

Image capture circuitry 650 may include two (or more) lens assemblies 680A and 680B, where each lens assembly may have a separate focal length. For example, lens assembly 680A may have a short focal length relative to the focal length of lens assembly 680B. Each lens assembly may have a separate associated sensor element 690. Alternatively, two or more lens assemblies may share a common sensor element. Image capture circuitry 650 may capture still and/or video images. Output from image capture circuitry 650 may be processed, at least in part, by video codec(s) 665 and/or processor 605 and/or graphics hardware 620, and/or a dedicated image processing unit or pipeline incorporated within circuitry 665. Images so captured may be stored in memory 660 and/or storage 665.

Sensor and camera circuitry 650 may capture still and video images that may be processed in accordance with this disclosure, at least in part, by video codec(s) 655 and/or processor 605 and/or graphics hardware 620, and/or a dedicated image processing unit incorporated within circuitry 650. Images so captured may be stored in memory 660 and/or storage 665. Memory 660 may include one or more different types of media used by processor 605 and graphics hardware 620 to perform device functions. For example, memory 660 may include memory cache, read-only memory (ROM), and/or random-access memory (RAM). Storage 665 may store media (e.g., audio, image and video files), computer program instructions or software, preference information, device profile information, and any other suitable data. Storage 665 may include one more non-transitory storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 660 and storage 665 may be used to tangibly retain computer program instructions or code organized into one or more modules and written in any desired computer programming language. When executed by, for example, processor 605 such computer program code may implement one or more of the methods described herein.

### Exemplary Embodiments

In one embodiment, a stereoscopic camera is provided. The stereoscopic camera may include a left camera lens and a right camera lens separated by a first distance. Additionally, the stereoscopic camera may include a left camera sensor and a right camera sensor separated by a second distance. The left camera sensor is associated with the left camera lens and the right camera sensor is associated with the right camera lens. The stereoscopic camera may include a controller that is configured to (i) receive image data from the left camera sensor and the right camera sensor, and (ii) encode the received image data. In some embodiments, the left camera lens' optical axis may be off-center of the left camera sensor. Additionally, or alternatively, the right camera lens' optical axis may be off-center of the right camera sensor. In some embodiments, the first distance may be measured from the left camera lens' optical center to the right camera lens' optical center. Further, the second distance may be measured from the left camera sensor's geometric center and the right camera sensor's geometric center. The first distance and the second distance may be different. The stereoscopic camera may include additional, less, or alternate functionality, including that discussed elsewhere herein.

For example, a further enhancement of the stereoscopic camera is the first distance being an interaxial distance of 64 mm. Alternatively, the first distance may be an interaxial distance between 58 mm and 74 mm or between 48 mm and 90 mm. In some embodiments, the first distance may be a fixed distance. Alternatively, the first distance may be a variable distance. A further enhancement of the stereoscopic camera may include wherein the controller may be further configured to (i) adjust the left camera lens and the right camera lens inward and outward in relation to each other, (ii) receive additional image data while the left and right camera lenses are adjusted, and (iii) generate a depth map based on the additional image data. In some embodiments, the image data may include a readout of the entire left and right camera sensors. Alternatively, the image data may include a readout of a first region of interest of the left camera sensor and a second region of interest of the right camera sensor, wherein the first and second regions of interest are determined based on where the left and right camera lenses overlap the left and right camera sensors. Further, the controller may only encode image data within the first and second regions of interest. The first and second regions of interest are adjusted in response to adjustment of the first distance between the left and right camera lenses. The left and right camera lenses may be high-powered lenses.

In another embodiment, a system including a stereoscopic camera and one or more processors coupled to a memory may be provided. The stereoscopic camera may include a left camera lens associated with a left sensor and a right camera lens associated with a right sensor. The left and right camera lens may be an interaxial distance away from each other, causing at least one of the left and right camera lenses to be offset from their respective image sensor. The at least one processor may be configured to: (i) adjust the interaxial distance between the left and right camera lens, (ii) obtain sensor readout data from the left and right sensors, (iii) remove unused portions of the sensor readout data, and (iv) cause to be displayed the sensor readout data on a display device. In some embodiments, the adjustment to the interaxial distance causes the right camera lens' optical axis to be off-center of the right sensor. Additionally, or alternatively, the left camera lens' optical axis may be off-center of the left camera sensor. The system may include additional, less, or alternate functionality, including that discussed elsewhere herein.

### Additional Considerations

As will be appreciated based upon the foregoing specification, the above-described embodiments of the disclosure may be implemented using computer programming or engineering techniques including computer software, firmware, hardware or any combination or subset thereof. Any such resulting program, having computer-readable code, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are examples only, and are thus not intended to limit in any way the definition and/or meaning of the term “processor.”

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are examples only and are thus not limiting as to the types of memory usable for storage of a computer program.

In one embodiment, a computer program is provided, and the program is embodied on a computer readable medium. In an example embodiment, the system is executed on a single computer system, without requiring a connection to a server computer. The application is flexible and designed to run in various environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process may also be used in combination with other assembly packages and processes.

As used herein, an element or step recited in the singular and preceded by the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A stereoscopic camera, comprising:
a first camera lens and a second camera lens separated by a first distance;
a first camera sensor and a second camera sensor separated by a second distance, wherein the first camera sensor is associated with the first camera lens and the second camera sensor is associated with the second camera lens, and wherein an optical axis of the first camera lens is off-center of the first camera sensor;
a controller configured to:
receive image data from the first camera sensor and the second camera sensor; and
encode the received image data.

2. The stereoscopic camera of claim 1, wherein the first camera lens and the second camera lens have an interaxial distance of 64 mm.

3. The stereoscopic camera of claim 1, wherein the first camera lens and the second camera lens have an interaxial distance between 58 mm and 74 mm.

4. The stereoscopic camera of claim 1, wherein the first camera lens and the second camera lens have an interaxial distance between 48 mm and 90 mm.

5. The stereoscopic camera of claim 1, wherein the first camera lens and the second camera lens have a fixed interaxial distance.

6. The stereoscopic camera of claim 1, wherein the first camera lens and the second camera lens have a variable interaxial distance.

7. The stereoscopic camera of claim 6, wherein the controller is further configured to:
move at least one of the first camera lens and the second camera lens to an adjusted position to cause a change in the variable interaxial distance;
capture additional image data while the first camera lens and second camera lens are in the adjusted position; and
generate a depth map based on the additional image data.

8. The stereoscopic camera of claim 1, wherein the image data includes a readout of an entirety of sensor data from the first camera sensor and the second camera sensor.

9. The stereoscopic camera of claim 1, wherein the image data includes a readout of a first region of interest of the first camera sensor where the first camera lens overlaps the first camera sensor, and a second region of interest of the second camera sensor where the second camera lens overlaps the second camera sensor.

10. The stereoscopic camera of claim 9, wherein the controller is configured to encode image data within the first and second regions of interest, and omit encoding sensor data outside the first region of interest and the second region of interest.

11. The stereoscopic camera of claim 9, wherein the first region of interest and the second region of interest are adjusted in accordance with the adjusted position.

12. The stereoscopic camera of claim 1, wherein each of the first camera lens and the second camera lens is a high-powered lens.

13. The stereoscopic camera of claim 1, wherein the first distance is measured from an optical center of the first camera lens to an optical center of the second camera lens, and the second distance is measured from a geometric center of the first camera sensor to a geometric center of the second camera sensor.

14. The stereoscopic camera of claim 13, wherein the first distance differs from the second distance.

15. The stereoscopic camera of claim 1, wherein an optical axis of the second camera lens is off-center of the second camera sensor.

16. A system, comprising:
a stereoscopic camera comprising a first camera lens associated with a first camera sensor and a second camera lens associated with a second camera sensor, the stereoscopic camera having a first interaxial distance;
one or more processors; and
a memory coupled to the one or more processors and comprising computer code executable by the one or more processors to:
adjust the stereoscopic camera to attain a second interaxial distance;
obtain sensor readout data from the first camera sensor and the second camera sensor;
remove unused portions of the sensor readout data to obtain a remaining sensor readout data; and
cause the remaining sensor readout data to be displayed on a display device.

17. The system of claim 16, wherein adjusting the stereoscopic camera causes an optical axis of the first camera lens to be off-center of the first camera sensor.

18. The system of claim 16, further comprising computer code executable by the one or more processors to:
determine a first region of interest of the first camera sensor where the first camera lens overlaps the first camera sensor; and
update the first region of interest of the first camera sensor in response to the adjustment of the stereoscopic camera.

19. The system of claim 17, further comprising computer code executable by the one or more processors to:
determine a second region of interest of the second camera sensor based on where the second camera lens overlaps the second camera sensor; and
update the second region of interest of the second camera sensor in response to the adjustment of the stereoscopic camera.

20. The system of claim 16, wherein the second interaxial distance is between 58 mm and 74 mm.
